(19) United States
(12) Patent Application Publication
(10) Pub. No.: US 2016/0288017 A1
(43) Pub. Date: Oct. 6, 2016

(54) Method and Apparatus for Weir Adjustment

(71) Applicant: Steven Ray Hall, Greeley, CO (US)

(72) Inventor: Steven Ray Hall, Greeley, CO (US)

(21) Appl. No.: 15/090,936

(22) Filed: Apr. 5, 2016

Related U.S. Application Data
(60) Provisional application No. 62/143,433, filed on Apr. 6, 2015.

(51) Int. Cl. B01D 17/02; B01D 17/12

(52) U.S. Cl. CPC B01D 17/0211; B01D 17/12

(57) ABSTRACT

Adjustable weir apparatus (101) with a wellhead separator system (6) fed by petrochemical source (1) with oil box (24) and water box (23) along with outlets for oil (25) and water (18). An adjustment assembly (12) may pass through a stuffing box (7), into a wellhead separator system (6), by way of a linkage assembly (13) connecting the adjustment assembly (12) to the adjustable weir assembly (5). The adjustable weir assembly (FIG. 5) may include an o-ring (34), a tube pin (15), an adjustable tube (22), and a nipple adapter (35) to allow adjustment while still maintaining an environment sufficiently proof against leakage.

This nonprovisional utility application claims priority to and the benefit of U.S. Provisional Application No. 62/143,433, filed Apr. 6, 2015, hereby incorporate herein by reference in its entirety.

### TECHNICAL FIELD

Generally, the inventive technology disclosed herein relates to improved devices, materials, and methods for the control of activity inside fluid phase separators. While the technology will mainly be discussed as it relates to petrochemical production, the inventive technology described herein may be generally applied to any type of fluid phase separation based on variable density, such as in cheese factories where whey and curds may need to be separated out or in any other fluid composition. More specifically, the inventive technology may involve methods, apparatus, techniques, and systems for the manual or automatic adjustment of a weir that may be accomplished without any need to open or even empty the separator. This inventive technology may be particularly suited for adjustment to account for variance in water density, oil density, mixture composition, or rate of flow. In certain embodiments, such improved methods can involve manually repositioning the weir device. Additional embodiments may involve automatic adjustment of the weir device. Additional embodiments contemplate either manual or automatic adjustment in response to a variety of sensors which may be adapted to the specific embodiments discussed herein. Further embodiments can represent improvements to the weir device itself for traditional or improved applications.

The current inventive technology provides numerous novel and commercially advantageous features, perhaps such as, but not limited to, increased productivity due to the ability to adjust without opening, accessing, or even emptying the separator, increased separator durability due to the ability to make adjustments more quickly, increased quality in product extracted from the separator due to more refined control over variables, increased efficiency, decreased propensity for accidents or product loss due to automatic adjustment capability, cost saving, and the like.

### BACKGROUND

Traditional fluid separators often can comprise a water box, an oil box, and a weir that facilitates fluidic communication between those boxes or chambers. Traditional weirs are fully internal relative to the separator apparatus. Some can be fixed dams, some can be weir tubes or devices. No external component is usually involved. Fluid changes have been accepted and operation was typically set to accommodate typical or anticipated conditions. Other-than-anticipated or typical fluidic conditions were accepted as acceptable variations. Only in the case of more drastic long term variations was attention or adjustment warranted. Such adjustment usually required access to the internal workings of the separator. This was undesired because breaches to the exterior of the separator involve significant activity and have created problems. Only when such changes were significant enough was the impact on maintenance of density and mixture composition accomplished. Pressure was reduced and needs for operator access were some concerns. Further, many of the traditional weirs can involve fixed plates which cannot be adjusted at all. Some do lend themselves to adjustment, but this fully internal configuration carried with it substantial limitations and concerns. More efficient and economical operations, as well as better environmental performance characteristics, are desired.

### SUMMARY OF INVENTION

Through either a manual or an automatic design, embodiments can satisfy a need for a single comprehensive solution to the limitations described above. It is therefore the object of the present invention to provide a weir configuration that can be adjusted without the need to shut down, depressurize, shut off production, or even partially or fully empty the separator. Additional objects of the current invention may also be to provide: 1) a manually, externally adjustable weir configuration; 2) a substantially real-time automatically adjustable weir configuration; 3) substantially real-time optimization of weir position based on any or all of the variables listed above, as well as any others; 4) a weir configuration that is automatically reactive to any or all of a variety of sensors; and 5) a variety of data outputs to either an operator or a computer that allow for optimal operation of the separator.

Accordingly, the objects of the methods and apparatus described herein address these and other problems and goals in a practical manner. Naturally, further objects of the inventive technology will become apparent from the description and drawings below.

### FIGURES

FIG. 1 is a schematic diagram of a separator configured according to one manually adjustable embodiment of the invention.

FIG. 2A is a diagram of an embodiment of one adjustable weir apparatus positioned in a cross-section of a separator.

FIG. 2B is a close up of the exterior portion of the embodiment shown in FIG. 2A.

FIG. 3A is a cross-section diagram showing an adjustable weir apparatus in its lowest configuration.

FIG. 3B is a close up of the exterior portion of the embodiment shown in FIG. 3A at its lowest adjustment level.

FIG. 4A is a cross-section diagram showing an adjustable weir apparatus in its highest configuration.

FIG. 4B is a close up of the exterior portion of the embodiment shown in FIG. 4A at its highest adjustment level.

FIG. 5A is a side cross section of an adjustable weir tube according to one embodiment of the invention.

FIG. 5B is a top view of the adjustable weir tube shown in FIG. 5A.

FIG. 6A is a perspective view of an adjustable weir tube according to one embodiment of the invention.

FIG. 6B is a perspective view of the inner tube of the adjustable weir shown in FIG. 6A.

FIG. 7 is a side view of an exterior portion of an embodiment showing graduations of the set level.

FIG. 8A is a perspective view of a threaded tube as may be used in one embodiment of the invention.

FIG. 8B is a side view of the threaded tube shown in FIG. 8A.

FIG. 9A is a perspective view of a second tube as may be used in one embodiment of the invention.

FIG. 9B is a first side view of the second tube shown in FIG. 9A.

FIG. 9C is a orthogonal side view of the second tube shown in FIG. 9A.

FIG. 10A is a perspective view of a rod clamp as may be used in one embodiment of the invention.

FIG. 10B is a first side view of the rod clamp shown in FIG. 10A.

FIG. 10C is a top view of the rod clamp shown in FIG. 10A.

FIG. 10D is a second side view of the rod clamp shown in FIG. 10A.

FIG. 11A is a side cross section of an adjustable weir tube according to another embodiment of the invention.

FIG. 11B is a top view of the adjustable weir tube shown in FIG. 11A.

FIG. 12 is a schematic diagram of a separator configured according to one automatically adjustable embodiment of the invention.

### DESCRIPTION OF PREFERRED EMBODIMENTS

The present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

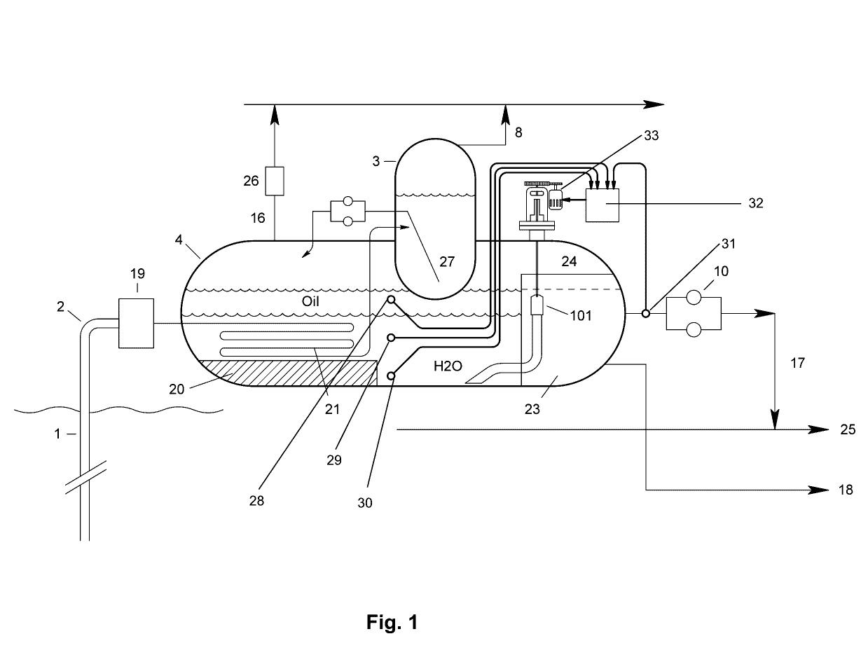

A traditional separator has those aspects that are well known. Such a traditional separator is generally shown in FIG. 1. While not limited to such an apparatus, the present adjustable weir is capable of functioning within such a traditional separator. As can clearly be seen in FIG. 1, there can be two chambers that may correspond to the traditional separator's water box (23) and oil box (24). These boxes may be referred to more generally as separation chambers. An adjustable weir may itself serve as a separator or a connector between such chambers. Such chambers may be open boxes, where separation is accomplished without a total seal, allowing air communication between the chambers inside the separator. They may also be closed boxes, where the only communication between the chambers is through a weir. Boxes may or may not be in fluidic communication with each other. Also in fashion similar to traditional separators, the separator may receive petrochemical production fluid from a petrochemical source. Petrochemical production fluid may enter the separator through an inlet, at least one of which may perhaps be present on the body of the separator. A separator may have at least one outlet, which may serve to facilitate the output of oil, water, gas, or other substances.

In this manner, the invention can function in a manner that is greatly improved over traditional designs. Fixed plate weirs usually involve the known concept that density will create variance in the traditional leveling effect or fluid source location. In a tube-based weir design, any fluid seeks its own level when fluidic communication is permitted. If the mixture is prone to separation or otherwise has varying density (as is the case, for example, with oil and water), the levels will vary as the materials separate into their respective volumes and the heavier material settles to the bottom of the mixture. Separators often, of course, act as petrochemical production fluid conditioners. Conditioning may typically be achieved by allowing separators to act as settlers, since oil and water naturally separate from each other when given sufficient time to settle.

Limiting on fixed plate or tubular weirs is the inability to adjust their position, which in turn creates an inability to react to important variables in the separation process or source fluid's characteristics. For example, the operators of a wellhead might desire to react to changes in densities experienced in the separator. However, the inability to adjust a fixed plate or tubular weir usually bars them from practically doing so. Potential variables which it is desirous to account for include, but are not limited to: water or other non-oil density, oil density, mixture composition, rate of flow through the separator, and the like. Traditional fixed-plate or tubular weirs can require operators to, at best, hazard estimates for the averages of the appropriate variables and attempt to optimize the weir height at the point of manufacture or initial installation prior to operations. Under these conditions, it is easy to see how the inability to react to variable changes leads to losses in production efficiency.

Even with newer weirs that may to some degree allow for adjustment, the fully-internal configuration requirement can significantly limit the ability to be reactive. Adjustable weirs may be adjustable plates or adjustable tubes, but prior adjustable systems often require the separator to be shut down, de-pressurized, and perhaps fully or partially drained so that the weir can be internally adjusted. Such a process may not allow for reactive adjustments as changes in these variables are noticed by an operator, occur in production, arise from well conditions or events, or as a sensor may indicate. As a result, production efficiency can still be lost. Sometimes, wellhead operators may have to choose between losses based on a suboptimal weir configuration or losses based on the time requirement to shut down a separator, depressurize it, perhaps drain it of materials, adjust the weir, and restart operations. Improved operation can be achieved by the above and any of the following embodiments.

An external control to adjust a weir is therefore a desirable improvement over prior systems. An external control may be a means of adjusting a weir without needing to access the interior of a separator. Such a control may be a manual control. A manual control may perhaps be a control that is manipulated by a user. Such a manual control could perhaps be a wheel, a handle, a button, or even a voice-activated mechanism or any other means of user manipulation. Such an external control may also be an automated control. An automated control may be a control that operates independently of user input. Such an automated control may be programmed by a user in advance before engaging in automatic control. In such cases, an automated control may be a prospective control. This may refer to a control that adjusts a weir in advance of anticipated condition, perhaps making it a production condition anticipatory control. Production conditions may vary based on, for example, time of day, temperature, weather, well burping, datalogging, and any other event which users may anticipate in advance and prospectively control for. Automated controls may also be sensor governed controls, which are controls that react to information from one of a variety of sensors. Such controls may be reactive controls, adjusting a weir to account for unanticipated alterations in production conditions. Finally, such a control may also comprise a reset. It may be desirable, due to data loss or damage or the like, to reset a control to a factory zero condition. Embodiments of the present technology may accomplish this goal.

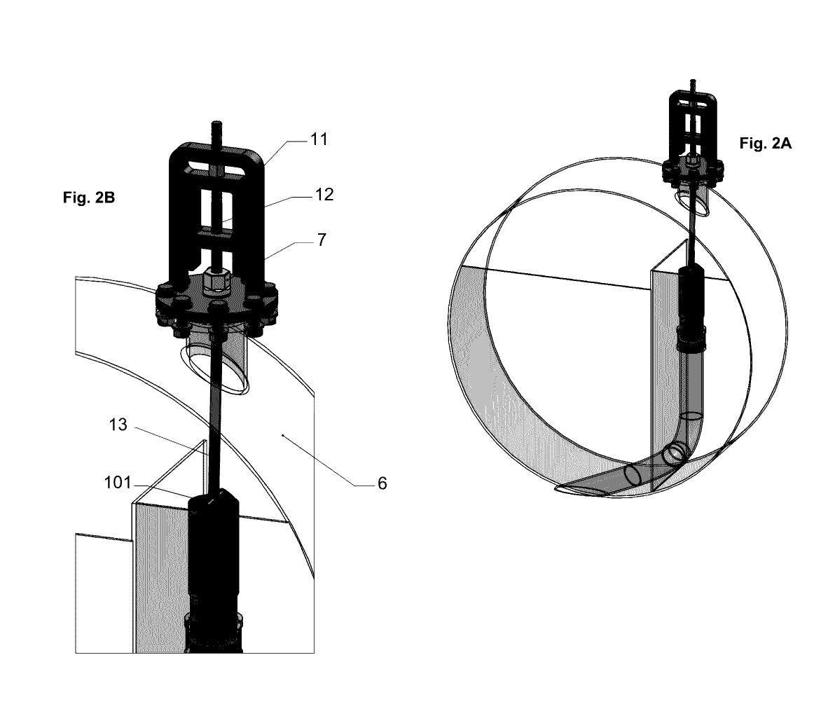

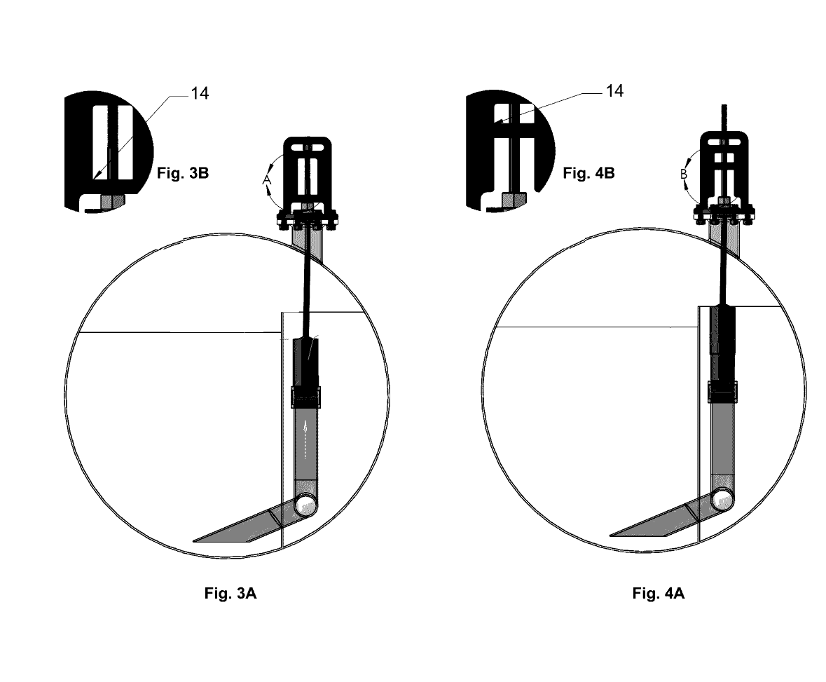

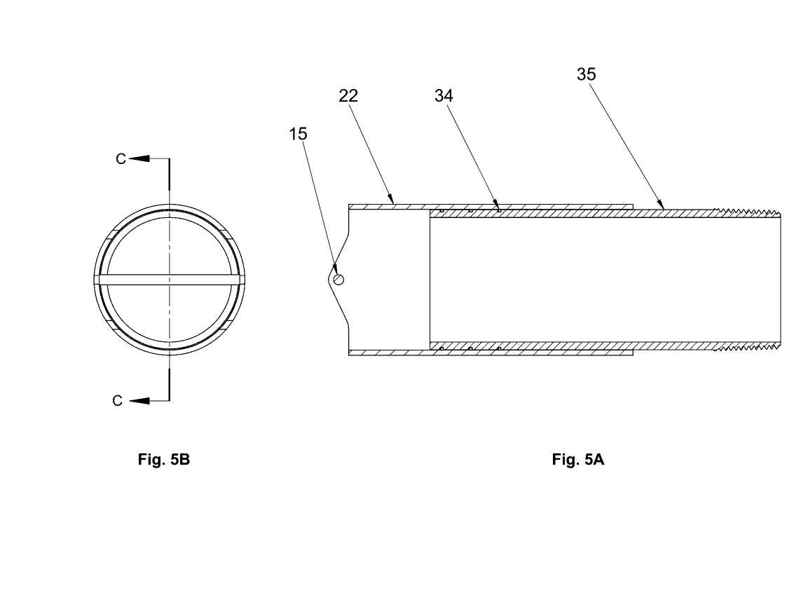

Referring now to FIG. 2B and others, in certain embodiments the adjustment assembly may include an indicator so that an operator can visually ascertain the position of the adjustable weir height (101) inside the separator (6). As can be appreciated, this knowledge can be coupled with data regarding water density, oil density, mixture composition, rate of flow, or a variety of other variables to determine whether the weir should be adjusted to improve production efficiency.

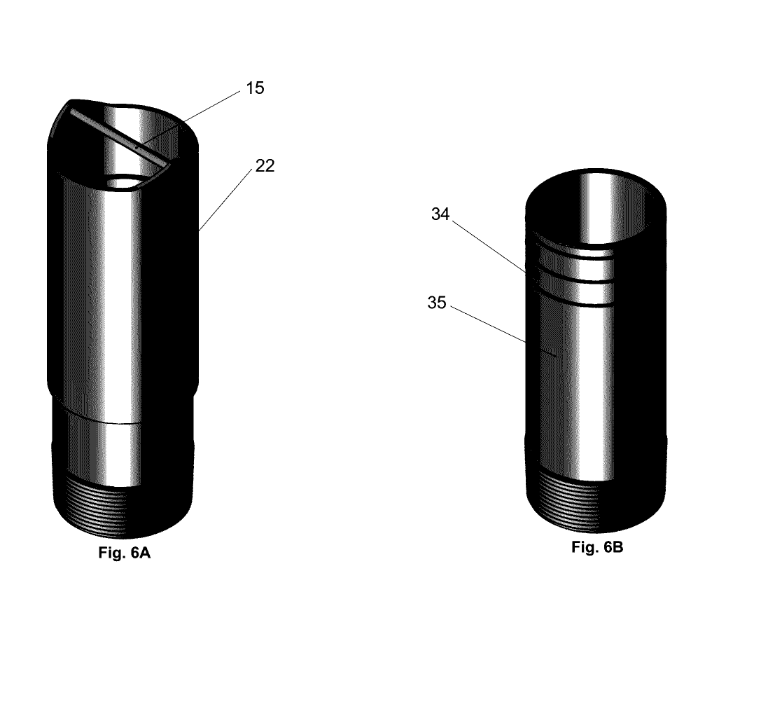

Furthermore, as detailed in FIG. 6A & 6B and others, the adjustable weir assembly may include a variety of features to ensure structural integrity and prevent unwanted, incidental material leakage into or through the walls of the weir. The adjustable weir assembly may utilize one or more o-rings (34), a tube pin (15), an adjustable tube (22), and a nipple adapter (35) individually or in combination with each other to allow for positional adjustment while preventing unwanted material leakage through the weir itself. FIG. 6B provides another view of these embodiments, leaving out the adjustable tube so that one configuration of o-ring features (34) might be better shown.

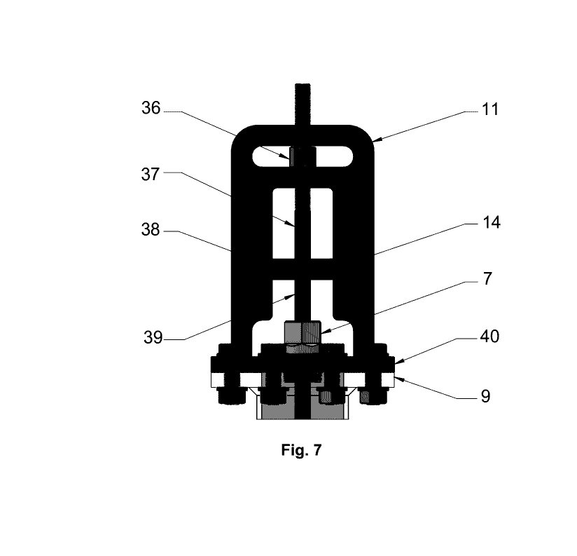

As shown in FIG. 7, in one embodiment the adjustment assembly may include several features to assist an operator in accomplishing any desired adjustment. An adjustment mount (11) may be present to anchor the apparatus to the separator. This may be accomplished in conjunction with a flange mount feature (40) that can anchor the assembly to a separator flange feature (9). In one embodiment, an adjustment nut (36) is present that may be turned in order to adjust the position of the adjustable weir assembly inside the separator. In one embodiment, this nut is anchored to a screw rod feature (37). The screw rod feature (37) may, in turn, be anchored to a lower rod shaft feature (39) by way of a rod clamp feature (14). In some embodiments, this rod clamp feature (14) may double as an indicator feature (14) in the presence of weir height graduations (3). Finally, as can be seen, the lower rod shaft feature (39) may pass through a stuffing box feature (7) before crossing the walls of the separator to connect to the linkage assembly.

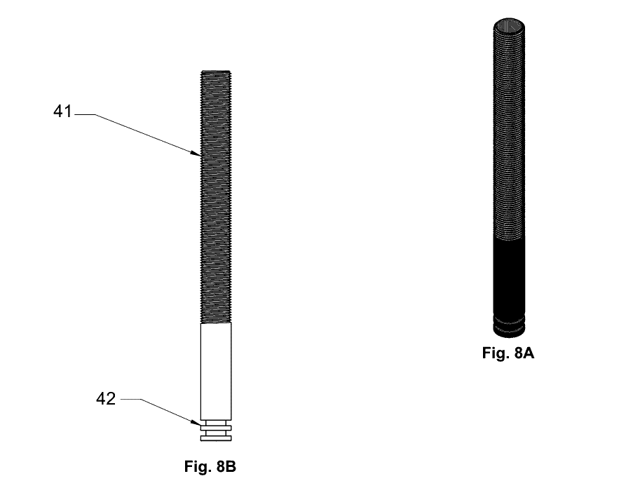

FIG. 8A & 8B gives a detailed view of the screw rod feature that may be present in certain embodiments of the invention. It should be noted that threads (41) for an adjustment nut feature (36) may be present in the upper portion of a screw rod feature. As FIG. 8B shows, it should also be appreciated that coupler features (42) may be present at the lower portion of a screw rod feature to allow for connection to other parts of the adjustment assembly.

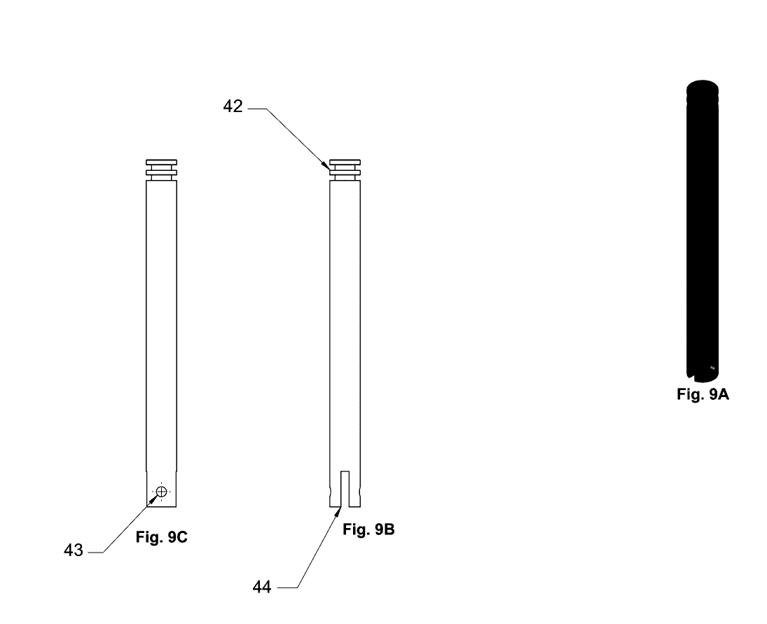

FIGS. 9A, 9B, and 9C give a detailed view of the lower rod feature that may be present in certain embodiments of the invention. It should be noted that coupler features (42) may be present at the upper portion of a lower rod feature to allow for connection to other parts of the adjustment assembly. As FIG. 9C shows, it should also be appreciated a hole for a linkage pin (43) and a slot for linkage (44) may be present at the lower end of a lower rod feature. In certain embodiments, these features may allow for connection between a lower rod feature and the linkage assembly.

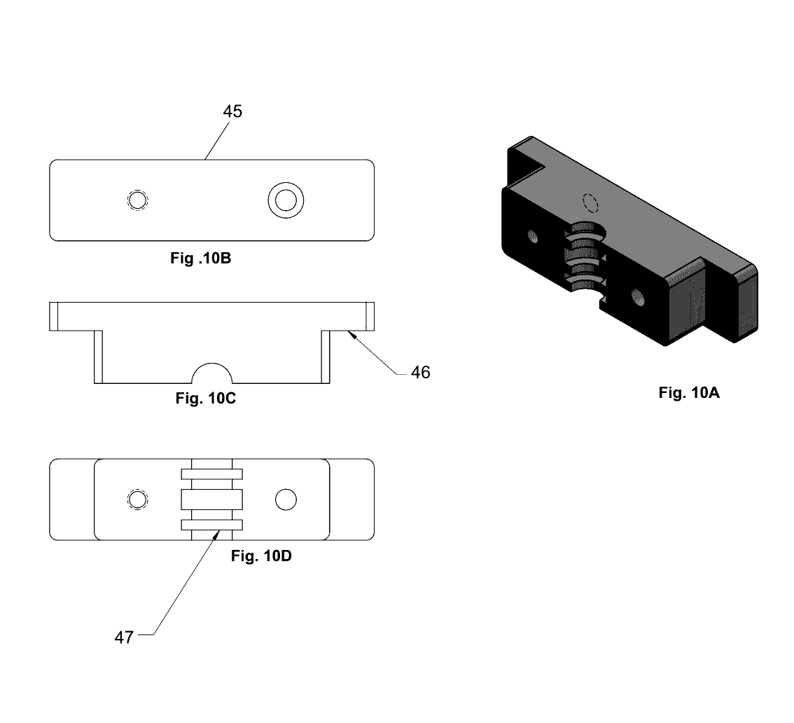

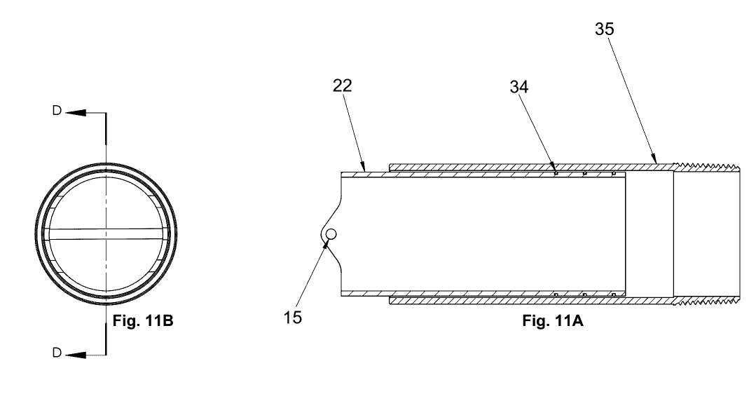

FIG. 10A-D give a detailed view of a rod clamp feature (14) possibly present in certain embodiments. Recall that, when present, this feature may serve to couple a screw rod feature to a lower rod feature. Also recall that, in certain embodiments where weir height gradations (38) are present in the adjustment assembly, a rod clamp feature (14) may double as an indicator feature. As FIG. 10A-D show, in certain embodiments, an opposing countersink (45) and threaded hole feature (47) may be present to allow a rod clamp feature (14) to connect two parts together. As can also be appreciated from FIG. 10 A-D, a relief feature (46) may be present that can allow a rod clamp feature (14) to rest against an adjustment mount feature and prevent it from rotating during positional adjustment of the weir.

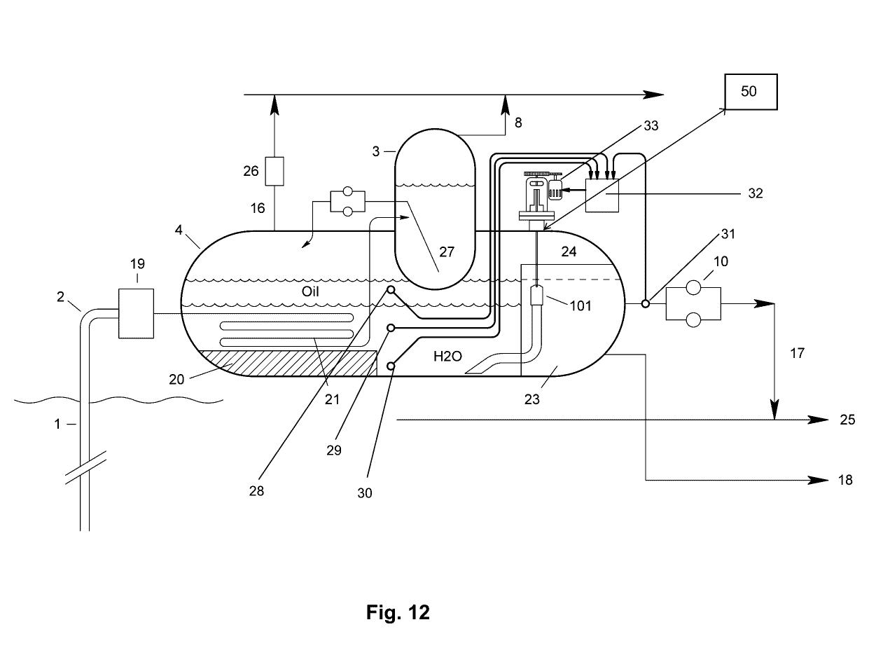

Additional embodiments of the current inventive technology may include the ability to externally adjust weir position based on 1) water or other separable fluid density; 2) oil density; 3) mixture composition; 4) rate of flow; and 5) any other relevant variables. It should also be appreciated that this adjustment can easily be accomplished automatically in response to a variety of sensors. Referring to the schematic diagram in FIG. 12, one or more sensors (28, 29, 30, 31) may be included. Potential sensors include, but are not limited to, 1) a densiometer; 2) a potentiometer; 3) a capacitance sensor; 4) a coriolis sensor; and 5) a tensiometer. It should be understood that any other known sensor that provides a relevant data input could also be present. It should also be understood that any or all such sensors (28, 29, 30, 31) may be present regardless of whether the weir is configured for automatic or external adjustment. The sensors (28, 29, 30, 31) might provide data to a computer capability (32) configured to adjust the weir automatically. The computer capability (32) may include hardware configuration, ASIC, programming or subroutines (32) or could also simply provide information, perhaps via a display (32), to an operator who could then adjust the weir externally. The computer capability can utilize and interpret one or more inputs to make a determination from which either an indication or even actual movement through a movement control (33), perhaps in real time, could be achieved as desired. Embodiments of the invention could also make use of a deadband to achieve and maintain stability.

One other benefit of embodiments of the invention is that eliminating the need to open the vessel in order to make any adjustment is the invention eliminates the release of Volatile Organic Compounds (VOCs) that are present in the pressurized gaseous components within the separation device. These VOCs are presently being vented to atmosphere in order to depressurize the separator or other containment device to allow for any adjustments to be made. VOCs are comprised of BTEX (benzene, toluene, ethylene and xylene), which are extremely hazardous to health and the environment, in addition to the numerous other hydrocarbon gaseous components such as methane, ethane, propane, isobutane, butane, isopentane, pentane, and hexane, among others. Embodiments of the present technology may serve to effectively sequester these and other, more benign, gaseous elements that may appear in the separation process. To sequester a gas may simply mean to keep it separate, in this case from atmosphere. Naturally, traditional separators may serve as gas sequesterers, but whenever adjustment is needed or maintenance must be performed or interior access is needed for any other reason, the sequestration may be interrupted and the gases may vent to atmosphere. Embodiments of the present technology may perhaps feature an access gas sequesterer (50), meaning petrochemical production gases may remain sequestered from atmosphere even when interior access is needed. An access gas sequesterer may substantially reduce the amount of petrochemical production gases, perhaps by 88%, perhaps by 90%, perhaps by 95%, perhaps by 99%, or anywhere within such a range.

An access gas sequesterer may be detachable, perhaps fitting over a seal in a separator hull. A detachable sequesterer may work by fitting over a seal and perhaps vacuum pumping to remove gases from the separator without allowing atmospheric venting. Once out of the separator, compounds may possibly be captured for either recycle or disposal without the environmental harms of atmospheric venting. In this manner, an access gas sequesterer may serve as a gas capturer, allowing the gases to be retained for any of a variety of purposes. A sequesterer may function as a gas recycler, allowing the gases to be harvested for uses in energy production or other productive applications. A sequesterer may also work as a gas disposer, simply allowing for the environmentally sound disposal of such gases. Another benefit of embodiments of the invention is the reduction or elimination of greenhouse gas emissions, such as by blowing down or by depressurization. A seal in a separator hull may function as a volatile organic compound seal, as discussed above, or any other gas that may incidentally be produced. Such a seal may be adjustable manually or automatically, in any of the fashions discussed above in the weir context or essentially in any other context. In addition to control of gas sequestration, such an access gas sequesterer can be used to control pressure inside of the separator when it perhaps acts as a pressure control. It may also be used to control the molar or other composition of the gases within the separator by acting as a partial pressure control.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, and techniques as well as devices to accomplish improved methods and apparatus for adjustment of a weir assembly in a wellhead separator. In this application, the improved techniques, including novel and unique methods and apparatus for weir adjustment, are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “clamp” should be understood to encompass disclosure of the act of “clamping”—whether explicitly discussed or not—and, conversely, were there effectively disclosure of the act of “clamping”, such a disclosure should be understood to encompass disclosure of an “clamping method and/or technique, and or device” and even a “means for clamping”. Such changes and alternative terms are to be understood to be explicitly included in the description.

Any priority case(s) claimed by this application is hereby appended and hereby incorporated herein by reference in its entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference and any and all art cited therein, or other information statement filed with the application are hereby appended and hereby incorporated by reference herein in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the methods, improvements and/or devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 715 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A fluid phase separation system comprising:
a fluid source that supplies a production fluid;
at least one inlet;
at least one outlet;
an adjustable weir; and
an external control to which said adjustable weir is responsive.

2-6. (canceled)

7. A fluid phase separation system as in claim 1, wherein said external control comprises a manual control.

8. (canceled)

9. A fluid phase separation system as in claim 1, wherein said external control comprises an automated control.

10. A fluid phase separation system as in claim 9, wherein said automated control comprises a user programmed control.

11. A fluid phase separation system as in claim 9, wherein said automated control comprises a sensor governed control.

12-13. (canceled)

14. A fluid phase separation system as in claim 1, wherein said adjustable weir comprises an adjustable weir responsive to at least one variable.

15. A fluid phase separation system as in claim 14, wherein said at least one variable comprises a variable selected from the group consisting of: water density, oil density, mixture composition, and rate of flow.

16-17. (canceled)

18. A fluid phase separation system as in claim 1, wherein said external control comprises a prospective control.

19. A fluid phase separation system as in claim 1, wherein said external control comprises a reactive control.

20. A fluid phase separation system as in claim 1, wherein said external control comprises a reset.

21-31. (canceled)

32. A method of separating fluids comprising the steps of:
providing a fluid production source;
receiving production fluid from said fluid production source;
externally setting at least one fluid division condition;
dividing production fluid into at least two constituent portions; and
outputting at least one of said constituent portions.

33-62. (canceled)

63. A fluid phase separation system comprising:
a fluid source that supplies a production fluid;
at least one inlet;
at least one separator outlet;
an access gas sequesterer; and
an external control to which said access gas sequesterer is responsive.

64. A fluid phase separation system as in claim 63, wherein said access gas sequesterer comprises a gas capturer.

65. A fluid phase separation system as in claim 64, further comprising a gas recycler.

66. A fluid phase separation system as in claim 63, wherein said access gas sequesterer comprises a gas seal.

67. A fluid phase separation system as in claim 66, wherein said gas seal comprises a volatile organic compound seal.

68. A fluid phase separation system as in claim 66, wherein said gas seal comprises an adjustable seal.

69. A fluid phase separation system as in claim 68, wherein said adjustable seal comprises a manually adjustable seal.

70. A fluid phase separation system as in claim 68, wherein said adjustable seal comprises an automatically adjustable seal.

71. A fluid phase separation system as in claim 63, wherein said access gas sequesterer comprises a pressure control.

72. A fluid phase separation system as in claim 63, wherein said access gas sequesterer comprises a partial pressure control.

73. A fluid phase separation system as in claim 63, wherein said access gas sequesterer comprises a gas disposer.

74-114. (canceled)
